(19) United States
(12) Patent Application Publication
(10) Pub. No.: US 2009/0286484 A1
(43) Pub. Date: Nov. 19, 2009

(54) METHOD AND SYSTEM FOR PERFORMING ONSITE MAINTENANCE OF WIRELESS COMMUNICATION SYSTEMS

(75) Inventors: LAN PHUNG, Fremont, CA (US); Robin Young, San Jose, CA (US)

Correspondence Address: FOGG & POWERS LLC, 5810 W 78TH STREET, SUITE 100, MINNEAPOLIS, MN, 55439, US

(73) Assignee: LGC Wireless, Inc., San Jose, CA (US)

(21) Appl. No.: 12/122,921

(22) Filed: May 19, 2008

(51) Int. Cl. H04B 17/00

(52) U.S. Cl. 455/67.11; 455/424

(57) ABSTRACT

Methods and systems for performing system maintenance in a wireless communication system are disclosed. In one embodiment, a plurality of system maintenance files for the wireless communication system are stored in a memory storage device; the memory storage device is physically coupled to an interface included in the wireless communication system; at least one of the plurality of system maintenance files is retrieved from the memory storage device; and at least one system maintenance action related to the at least one system maintenance file is automatically performed. In another embodiment, a plurality of system maintenance files for the wireless communication system is attached to a first email message; the email message is emailed to the wireless communication system; at least one of the plurality of system maintenance files are retrieved from the first email message; and at least one system maintenance action related to the at least one system maintenance file is automatically performed. In some embodiments, the wireless communication system comprises a distributed antenna system.

### FIELD OF THE INVENTION

The present invention relates generally to the wireless communications field, and more specifically, but not exclusively, to an improved method and system for performing onsite maintenance of wireless communication systems.

### BACKGROUND OF THE INVENTION

In conventional distributed architectures for wireless communication systems, the base station and transceiver equipment is typically located at the customers' sites where communication coverage and capacity are needed. Consequently, the onsite base station and transceiver equipment is not readily accessible for maintenance (e.g., performance monitoring, problem notification, diagnosis, debugging and repair).

Remotely monitoring the system's performance is a technique used to detect performance degradation and/or service-impacting problems, which can also be used to notify the service providers, customers or users as these problems arise. However, the conventional approach used to diagnose and repair such problems is to send technical personnel to the customer's site. Consequently, the wireless communication service at the customer's site can be lost or degraded for a substantial period of time, or at least until the technical personnel arrive and can diagnose and resolve the problem. Also, the provision of such technical support at the customer's site is time-intensive and thus can be costly for the service provider and/or customer involved. Therefore, a pressing need exists for a suitable method for performing onsite maintenance of wireless communication system hardware and software that can reduce the need for technical support personnel at customers' sites and thus minimize maintenance costs.

### SUMMARY OF THE INVENTION

One exemplary embodiment comprises a method for performing system maintenance in a wireless communication system. The method comprises storing a plurality of system maintenance files for the wireless communication system in a memory storage device; physically coupling the memory storage device to an interface included in the wireless communication system; retrieving from the memory storage device at least one of the plurality of system maintenance files; and automatically performing at least one system maintenance action related to the at least one system maintenance file.

In another exemplary embodiment, a distributed antenna system comprises a hub unit and a plurality of remote antenna units. The hub unit is communicatively coupled to plurality of remote antenna units. The hub unit comprises a processing unit, and an interface communicatively coupled to the processing unit. The processing unit is operable to: determine when a memory storage device is physically coupled to the interface; and when the memory storage device is physically coupled to the interface, determine if at least one system maintenance file is stored on the memory storage device and, if at least one system maintenance file is stored on the memory storage device, automatically perform at least one system maintenance operation related to the at least one system maintenance file.

Another exemplary embodiment comprises a method for performing system maintenance in a wireless communication system. The method comprising attaching a plurality of system maintenance files for the wireless communication system to a first email message; emailing the email message to the wireless communication system; retrieving from the first email message at least one of the plurality of system maintenance files; and automatically performing at least one system maintenance action related to the at least one system maintenance file.

In another exemplary embodiment, a distributed antenna system comprises a hub unit; and a plurality of remote antenna units. The hub unit is communicatively coupled to plurality of remote antenna units. The hub unit comprises a processing unit, and an interface communicatively coupled to the processing unit. The processing unit is operable to receive a first email message comprising at least one system maintenance file attached thereto. The processing unit is operable to perform at least one system maintenance operation related to the at least one system maintenance file after the processing unit receives the first email message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts an exemplary wireless communication system, which can be used to implement one or more embodiments of the present invention;

FIGS. 2A and 2B are related diagrams depicting an exemplary method for performing onsite maintenance of a wireless communication system, which can be used to implement one or more embodiments of the present invention; and

FIG. 3A and 3B are related diagrams depicting a second exemplary method for performing remote maintenance of a wireless communication system, which can be used to implement one or more embodiments of the present invention.

### DETAILED DESCRIPTION OF PREFERRED EMBODIMENT(S)

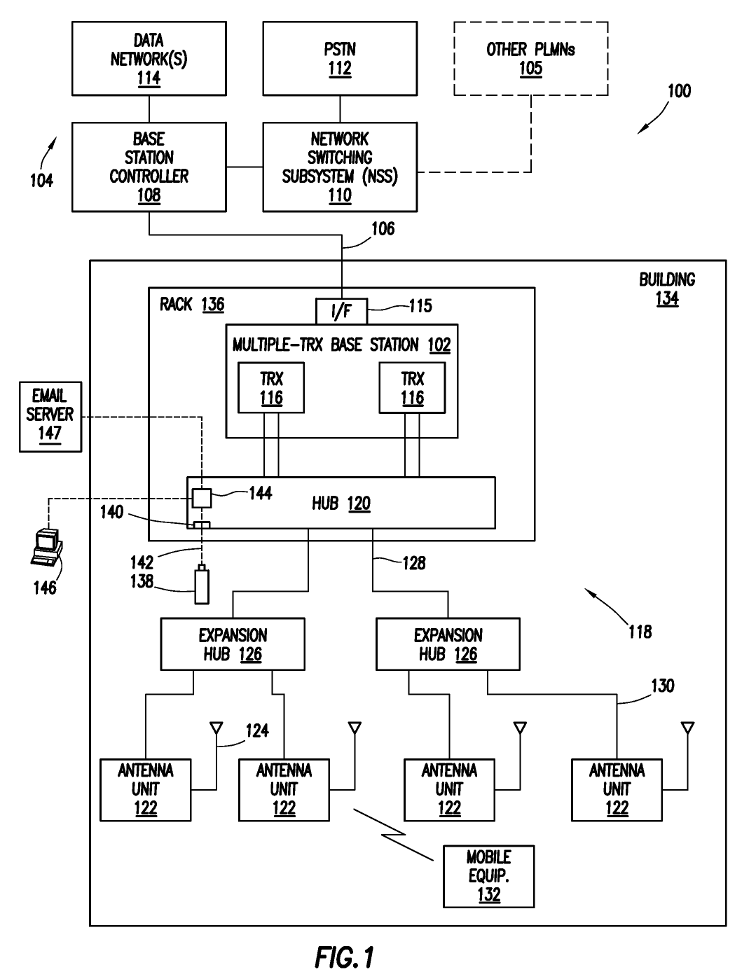

With reference now to the figures, FIG. 1 depicts an exemplary wireless communication system 100, which can be used to implement one or more embodiments of the present invention. In the exemplary embodiment shown in FIG. 1, system 100 includes a multiple-Transceiver (multiple-TRX) base station 102 that is communicatively coupled to a public land mobile network (PLMN) 104 via a backhaul link 106. For example, in one or more embodiments, multiple-TRX base station 102 can be implemented with a multiple-TRX pico base station. However, it should be understood that the functionality depicted and described above with respect to FIG. 1 can, in other embodiments, also be implemented using base stations other than multiple-TRX pico base stations. For example, the functionality depicted in FIG. 1 can also be implemented using single-TRX pico base stations, micro base stations, macro base stations, and the like. Also, although such functionality is described herein primarily as being implemented in an integrated base station device, it should be understood that in other embodiments, such functionality can be implemented using, for example, separate network nodes.

Within network 104, backhaul link 106 is coupled to a base station controller (BSC) 108, which is, in turn, coupled to a network switching subsystem (NSS) 110. NSS 110 is coupled to a public switched telephone network (PSTN) 112 and to other PLMNs 105. Also, BSC 108 is communicatively coupled to one or more data nodes for communicatively coupling BSC 108 (and multiple-TRX base station 102) to one or more data networks 114, such as, for example, the Internet.

BSC 108 performs various conventional BSC functions such as, for example, radio channel allocation, call handovers between base stations, configuring multiple-TRX base station 102, handling alarms, and performing management functions. BSC 108 includes, or is communicatively coupled to, an appropriate network element (e.g., a packet control unit or PCU) for directing traffic to and from data network 114.

NSS 110 performs various communication functions such as, for example, circuit switching, and providing applications and call features to mobile subscribers, such as call ringing and roaming. For example, NSS 110 can include a mobile switching center (MSC) and other functionality such as a home location register (HLR) and visitor location register (VLR). In some embodiments, certain of the functions performed by BSC 108 and NSS 110 may instead be performed by multiple-TRX base station 102. For example, multiple-TRX base station 102 may include a local server which is configured with a Linux (or other suitable) operating system to implement the functions performed.

For the exemplary embodiment shown, multiple-TRX base station 102 includes a plurality of TRX units 116. In some implementations, multiple-TRX base station 102 can include two TRX units 116. However, it should be understood that multiple-TRX base station 102 can also include a larger number of TRX units (e.g., four TRX units, etc.) in other implementations. In the exemplary implementation shown, each TRX unit 116 is used to output a relatively low power (e.g., less than one watt) RF channel.

For the exemplary implementations shown, multiple-TRX base station 102 includes a suitable interface 115 to communicatively couple multiple-TRX base station 102 (and the plurality of TRX units 116) to network 104. In some embodiments, multiple-TRX base station 102 may use an Internet Protocol (IP) backhaul connection in which voice and data signals are converted to IP packets for communications via backhaul link 106 to BSC 108 (e.g., using a cable modem or DSL modem). In other embodiments, multiple-TRX base station 102 may use a T1 or E1 connection (i.e., a time division multiplexing or TDM connection) for backhaul link 106. In yet other embodiments, a wireless link (e.g., WIMAX wireless link) may be used to provide the functions of backhaul link 106, in which case interface 115 could provide a suitable WIMAX interface.

Each TRX unit 116 communicates in a single bi-directional RF channel of a particular licensed wireless RF communications band. Each such bi-directional RF channel includes an uplink channel and downlink channel. In some exemplary implementations, each TRX unit 116 of multiple-TRX base station 102 can transmit and receive 200 kHz GSM uplink and downlink RF channels within the 850 MHz frequency band. In other implementations, each TRX unit 116 can transmit and receive in 1.25 MHz Code-Division Multiple Access (CDMA) uplink and downlink RF channels within the 1900 MHz frequency band. In yet other implementations, TRX units 116 can support other wireless protocols such as, for example, protocols for other GSM bands or other CDMA bands, and the GPRS, EDGE, UMTS, W-CDMA, LTE, EVDO, CDMA2000, UMB, HSPA or WIMAX protocols. Furthermore, it should be understood that multiple-TRX base station 102 may support a plurality of different wireless protocols so that the different protocols can be supported by a single multi-mode multiple-TRX base station 102. For example, one TRX unit 116 may support the use of one wireless protocol, and one or more of the other TRX units 116 may support other wireless protocols.

For the exemplary implementations shown in FIG. 1, multiple-TRX base station 102 is also communicatively coupled to a distributed antenna system (DAS) 118. DAS 118 includes a multi-port repeater hub 120 which is communicatively coupled to a plurality of antenna units 122. Each antenna unit 122 includes or is coupled to at least one antenna 124, which receives and radiates RF signals from a respective antenna unit 122.

DAS 118 is used to provide RF wireless coverage from the remotely located and spatially separated antenna units 122 using the capacity provided by multiple-TRX base station 102. An example of a suitable distributed antenna system that can be used to implement DAS 118 is the InterReach FUSION in-building distributed antenna system that is commercially available from ADC Telecommunications, Inc., of Eden Prairie, Minn. For the embodiments depicted in FIG. 1, the TRX units 116 of multiple-TRX base station 102 are preferably centralized and can be located in a secure location (e.g., a utility or server closet or room).

In the embodiments depicted in FIG. 1, hub 120 is communicatively coupled to antenna units 122 via one or more intermediate expansion hubs 126. In such implementations, hub 120 is communicatively coupled to each of expansion hubs 126 via one or more cables 128. For example, in some embodiments, cables 128 can include one or more fiber optic cables. Also, antenna units 122 are communicatively coupled to expansion hub 126 via appropriate cabling 130 (e.g., thin coaxial cabling, CATV cabling, fiber optic cabling, and the like). Notably, in other embodiments, hub 120 can be communicatively coupled directly to any of antenna units 122.

In one or more preferred embodiments, multiple-TRX base station 102 and hub 120 of DAS 118 may be installed in a building 134 in which wireless communication coverage and capacity is to be provided. For example, building 134 is preferably not controlled by the service provider that operates network 104. In other words, building 134 can be a customer premise that is owned, controlled, or otherwise used by a person or entity other than the service provider that operates network 104, such as, for example, an “enterprise” (e.g., a business, non-profit organization, government entity, and the like). Examples of such buildings include, without limitation, office buildings, shopping centers, educational and/or governmental buildings, airports, sports or entertainment arenas or stadiums, hospitals, single family homes, condominiums, apartments, hotels or motels, and the like.

Antenna units 122 form one or more coverage areas, and are distributed throughout building 134 in order to form one or more coverage areas that substantially include all of the occupied areas within building 134. For the exemplary embodiments shown, mobile communications equipment 132 (e.g., one or more cellular phones, radiotelephones, mobile phones, and the like) within a coverage area can be communicatively coupled to network 104 via one or more of antenna units 122, one or more of expansion hubs 126, hub 120, multiple-TRX base station 102, and backhaul connection 106.

For some embodiments, system 100 also includes a Universal Serial Bus (USB) device 138 and a USB port 140. For example, USB device 138 (e.g., also known as a USB key, USB thumb-drive, flash drive, keychain drive, jump drive, etc.) can be implemented with a flash memory device that operates in accordance with the standard USB protocol (e.g., USB 2.0 connectivity). In some embodiments, USB device 138 can be implemented as a flash memory device that also includes a built-in CPU. In such implementations, the built-in CPU is enabled to execute software and/or firmware instructions stored in the memory portion of USB device 138. In other embodiments, the functions of USB device 138 can also be performed by (and USB device 138 may be replaced with) another suitable storage device, such as, for example, a memory stick, CF card, memory stick card, SD card, disk drive, Blu-ray, tape drive, and similar types of memory storage devices. In some embodiments, the software and/or firmware instructions can be implemented, for example, as one or more system maintenance request files that can describe what system maintenance operations are to be performed. For example, such system maintenance request files may include, but are not limited to, firmware update file(s), configuration parameter list(s), bootloader, kernel or file system files, system recovery files, and script files.

As denoted by the dashed lines 142, a user can insert USB device 138 into USB port 140 to initiate execution of the software and/or firmware stored in the memory portion of USB device 138. For some embodiments, USB port 140 is communicatively coupled to a processing unit (e.g., processing unit 144) in the wireless communication system equipment involved (e.g., hub 120). In other words, as described in detail below, a user (e.g., customer) can use USB device 138 to perform onsite maintenance of the wireless communications equipment (e.g., multiple-TRX base station 102, one or more of TRX units 116, hub 120, one or more of expansion hubs 126, and one or more of antenna units 122) at the remotely located site.

More precisely, USB device 138 can be used, for example, for diagnosing and debugging problems that may arise in the wireless communication system at a customer's site, executing script stored in the USB device, copying system settings for the wireless communication system involved, downloading firmware for maintenance use by the wireless communication system involved, and as a rescue disk to archive the customer's unique data and settings in case of an emergency situation for the wireless communications equipment involved. For example, a service provider can use a computer 146 located anywhere (e.g., outside of the building 134) to prepare and store system maintenance files (e.g., configuration information and software and/or firmware) in USB device 138 for wireless communication system maintenance, troubleshooting, and rescue or recovery functions. The USB device 138 can then be conveyed to the building 134 (for example, by having someone carry the USB device 138 to the building 134 or by mailing the USB 138 to the building 134). After the USB device 138 has been conveyed to the building 134, the USB device 138 can be inserted into the USB port 140 to initiate processing of the system maintenance files stored in the memory portion of USB device 138. The computer 146 that is used to prepare and store such configuration information and/software on the USB device 138 can be any suitable type of computer device (for example, a desktop personal computer, laptop) and need not be located within the building 134 in which the wireless system 100 is deployed.

In other embodiments, such system maintenance files are communicated to the processing unit 144 using email messages. In such an embodiment, such system maintenance files are communicated to the processing unit 144 as one or more attachments to an email message. In such an embodiment, the processing unit 144 has a suitable communication link to an email server 147 with which that processing unit 144 is able to send and receive email messages. For example, in one implementation of such an embodiment, the processing unit 144 is communicatively coupled to the email server 147 using an Internet connection that is already otherwise provided at the building 134. Email traffic is typically permitted to pass through corporate firewalls without special arrangements. The use of email to communicate such system maintenance files obviates the need for the USB device 138 to be physically conveyed to the building 134 (or the need of a technician to travel to the building 134) but without requiring a dedicated communication link between the processing unit 144 of the system 100 and an off-site monitoring computer (for example, computer 146) or, if a pre-existing Internet connection were to be used, without requiring some special arrangement to allow such monitoring traffic to pass through a corporate firewall.

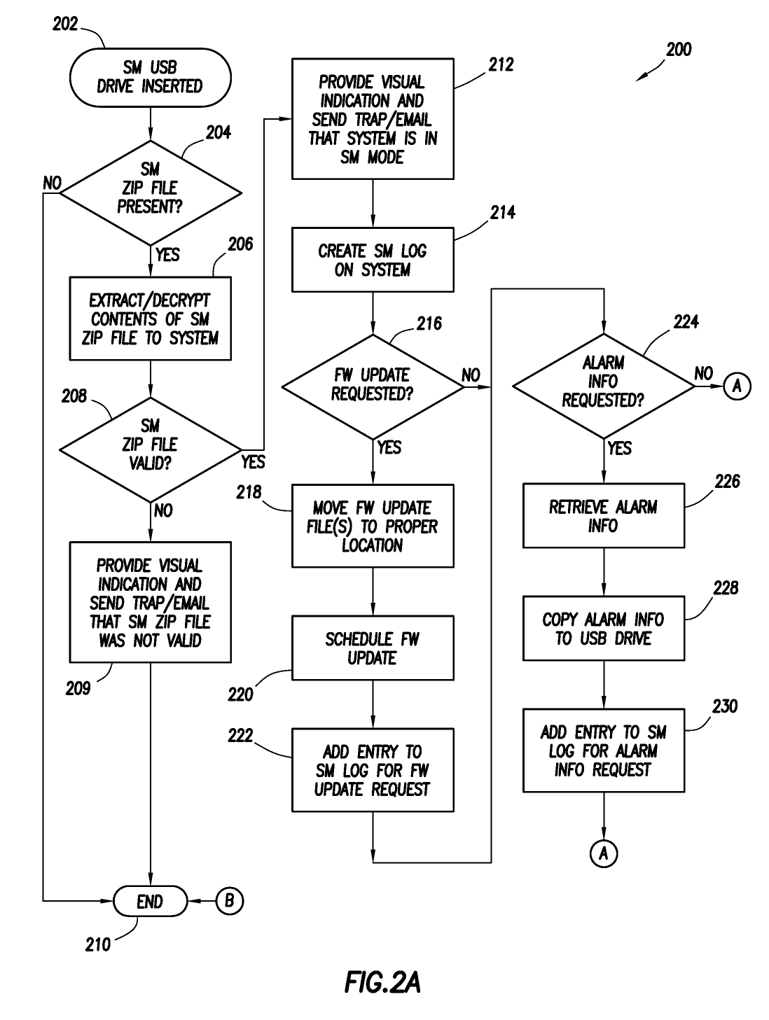

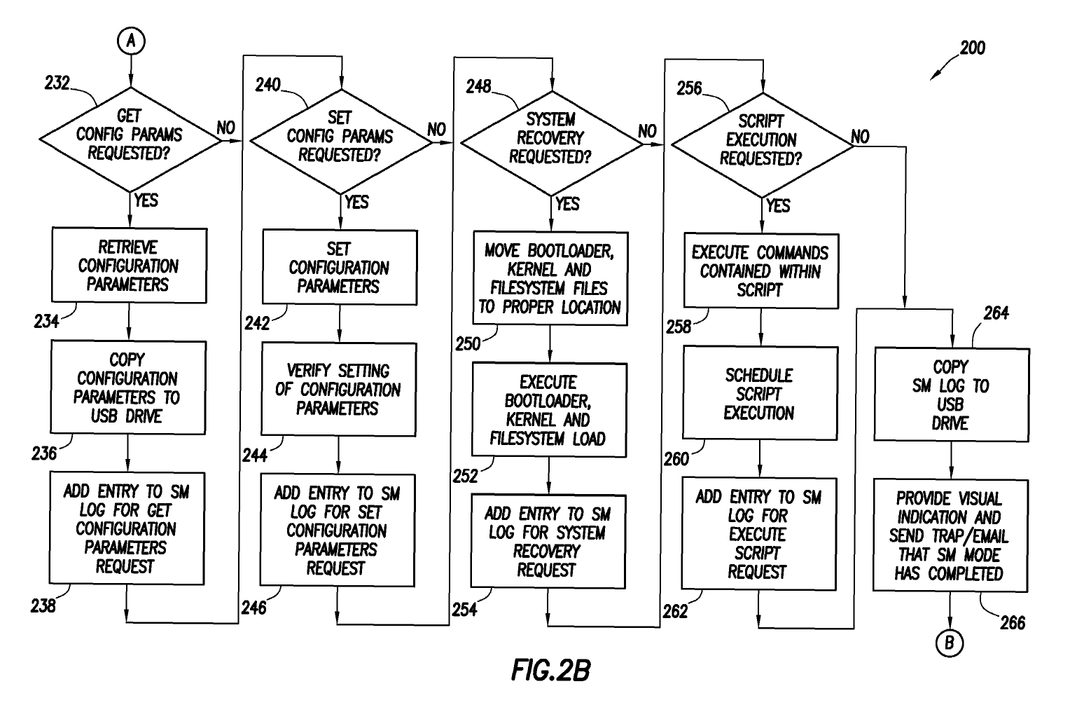

FIGS. 2A and 2B are related diagrams depicting an exemplary method 200 for performing onsite maintenance of a wireless communication system, which can be used to implement one or more embodiments of the present invention. For example, in some embodiments, method 200 can be used for performing onsite system maintenance (e.g., diagnosis, debugging, recovery, rescue, repair, etc.) of one or more components of wireless communication system 100 depicted in FIG. 1 at a customer's or user's location. More precisely, for example, in some embodiments, method 200 can be used in conjunction with USB device 138 and USB port 140 to perform onsite system maintenance of one or more subsystems or components of wireless communication system 100.

Referring now to FIGS. 1, 2A and 2B for one or more embodiments, exemplary method 200 begins with the insertion of a system maintenance USB drive into a suitable USB connection (step 202). For example, a customer or user may decide to perform system maintenance on the remotely located equipment of system 100, such as one or more of multiple-TRX base station 102, TRX units 116, hub 120, expansion hubs 126 (e.g., if expansion hubs are included in the system involved), and antenna units 122. As such, for the exemplary embodiments shown, the customer or user can insert USB device 138 into USB port 140 located in hub 120. The processing unit 144 of the hub 120 is operable to determine when the USB device 138 is inserted into the USB port 140 (for example, by executing suitable software or firmware). After the processing unit 144 determines that the USB device 138 has been inserted in the USB port 140 of hub 120, the processing unit 144 then performs the processing described below automatically (that is, without requiring further input from a user).

In some embodiments, a suitable operating system for performing onsite maintenance (e.g., diagnosis, debugging, rescue, recovery, etc.) can be booted up or launched from USB device 138. For example, USB device 138 can include a Red Boot, boot manager or boot strap loader program in its memory portion that starts up a suitable operating system for performing onsite maintenance that can be executed, for example, by processing unit 144 in hub 120, as soon as USB device 138 is inserted into USB port 140. As another example, USB device 138 can store a complete operating system for performing onsite maintenance that can be executed, for example, by a suitable processing unit or CPU disposed in USB device 138, as soon as USB device 138 is inserted into USB port 140.

For example, a suitable operating system including computer-executable instructions for performing onsite maintenance of wireless communication system 100 can be stored in one or more (e.g., concatenated) compressed Tar (tape archive) formatted files (e.g., Tar balls) in the memory portion of USB device 138. The operating system can be stored in USB device 138 in the form of a suitable shell script or programming language (e.g., Linux, Unix, Windows, JCL, DCL, Apple script, and the like).

Next, a processing unit (e.g., processing unit 144 of hub 120, or a built-in CPU of USB device 138) determines if a system maintenance file is stored in the memory section of the inserted USB drive (step 204). For example, such a system maintenance file can be a zip (compressed) file, and the contents of the file can be protected from unauthorized use by a suitable encryption algorithm. Also, for example, such a system maintenance file may include a system maintenance request file, and the system maintenance request file may include, but is not limited to, one or more firmware update file(s), configuration parameter list(s), bootloader, kernel or file system files, and script files. If (at step 204) the processing unit determines that no system maintenance file is stored in the inserted USB drive, then the flow can be terminated (step 210).

If (at step 204) the processing unit determines that a system maintenance file is stored in the inserted USB drive, then the processing unit can extract the contents of the system maintenance file from the memory section of the USB drive, and store the contents in memory associated with the system processing unit involved (step 206). For example, in some embodiments, the processing unit can decompress or unzip the contents of the system maintenance file stored in the USB drive, execute a suitable algorithm to decrypt the contents (e.g., if encrypted), and store the contents in memory associated with the system's processing unit (e.g., processing unit 144 in hub 120).

Next, the processing unit involved determines if the extracted file is a valid system maintenance file (step 208). For example, the processing unit can execute a suitable authentication algorithm on the contents of the extracted file to determine if the file is valid. If (at step 208) the processing unit determines that the extracted file is not a valid system maintenance file, then the processing unit can indicate to the user that the system maintenance file was not valid (step 209) and then the flow can be terminated (step 210). For example, in some embodiments, the processing unit (e.g., processing unit 144) can provide a visual indication (lit LED, etc.) to the user that the system maintenance file was not valid. Also, for example, the processing unit can send suitable information to a maintenance trap or in an email message, which indicates to a user (and/or customer, agent, service provider, support personnel, etc.) that the system maintenance file was not valid.

If (at step 208) the processing unit determines that the extracted file is a valid system maintenance file, then the processing unit can indicate to the user that the system involved is in a system maintenance mode of operation (step 212). For example, in some embodiments, the processing unit (e.g., processing unit 144) can provide a visual indication (lit LED, etc.) to the user that the system, subsystem or component involved (e.g., multiple-TRX base station 102) is operating in a system maintenance mode. Also, for example, the processing unit can send suitable information to a maintenance trap or in an email message, which indicates to a user (and/or customer, agent, service provider, support personnel, etc.) that the system is operating in a system maintenance mode.

Next, for some embodiments, the processing unit (e.g., processing unit 144) creates and stores a system maintenance log for the system involved (step 214). For example, the system maintenance log can be used to store entries associated with specific system maintenance procedures or responses to requests that have been performed. Next, the processing unit determines if a firmware update request has been made (step 216). For example, the processing unit can determine from the contents of the system maintenance request file if a firmware update request is included. If (at step 216) the processing unit determines that a firmware update request has not been made, then the flow proceeds to step 224.

If (at step 216) the processing unit determines that a firmware update request has been made, then the processing unit conveys the firmware files to be used for the update(s) to a suitable memory location in the equipment involved until the firmware update(s) can be performed (step 218). The processing unit then schedules a suitable timeframe when the firmware update(s) can occur (step 220). For example, the processing unit can select a timeframe when the operations of the multiple-TRX base station 102 are not likely to be disrupted significantly by the update process. Once the firmware update process is complete, the processing unit can add a suitable entry to the system maintenance log, which indicates that the firmware update request procedure has been performed (step 222). The flow can then proceed to step 224.

Returning to step 216, if the processing unit determines that no firmware update request has been made, the processing unit then determines if a system maintenance alarm information request has been made (step 224). For example, processing unit 144 in hub 120 can determine from the extracted contents of the system maintenance request file if an alarm information request is included. Such system maintenance alarm information may include, for example, information indicating that the system (e.g., processing unit 144) has identified a problem with the performance of the system, subsystem or component involved, and the problem requires system maintenance to be performed. If (at step 224) the processing unit determines that an alarm information request has not been made, then the flow proceeds to step 232.

If (at step 224) the processing unit determines that a system maintenance alarm information request has been made, the processing unit retrieves the alarm information from a suitable memory location in the system where the alarm information has been stored (step 226). The processing unit then stores the retrieved alarm information in the memory area on the inserted USB drive (step 228). Once the alarm information has been copied to the USB drive, the processing unit can add a suitable entry to the system maintenance log, which indicates that the alarm information request procedure has been performed (step 230). The flow can then proceed to step 232.

Returning to step 224, if the processing unit determines that an alarm information request has not been made, the processing unit then determines if a request to retrieve system configuration parameters has been made (step 232). For example, processing unit 144 in hub 120 can determine from the extracted contents of the system maintenance request file if a request to retrieve the system's configuration parameters is included. If (at step 232) the processing unit determines that a request to retrieve system configuration parameters has not been made, then the flow proceeds to step 240.

If (at step 232) the processing unit determines that a request to retrieve system configuration parameters has been made, then the processing unit retrieves a configuration parameter list from a suitable memory location in the system where the system's configuration parameter information has been stored (step 234). The processing unit then stores the retrieved configuration parameter information in the memory area on the inserted USB drive (step 236). Once the system's configuration parameter information has been copied to the USB drive, the processing unit can add a suitable entry to the system maintenance log, which indicates that the retrieve configuration parameters request procedure has been performed (step 238). The flow can then proceed to step 240.

Returning to step 232, if the processing unit determines that a request to retrieve system configuration parameters has not been made, then the processing unit determines if a request to set the system's configuration parameters has been made (step 240). For example, processing unit 144 in hub 120 can determine from the extracted contents of the system maintenance request file if a request to set the system's configuration parameters is included. If (at step 240) the processing unit determines that a request to set the system's configuration parameters has not been made, then the flow proceeds to step 248.

If (at step 240) the processing unit determines that a request to set the system's configuration parameters has been made, then the processing unit retrieves a configuration parameter list from the memory location on the USB drive, and sets the system's configuration parameters in accordance with the list (step 242). The processing unit then verifies that the configuration parameter have been set in accordance with the list (step 244). Once the system's configuration parameters have been set and verified, the processing unit can add a suitable entry to the system maintenance log, which indicates that the set configuration parameters request procedure has been performed (step 246). The flow can then proceed to step 248.

Returning to step 240, if the processing unit determines that a request to set the system's configuration parameters has not been made, then the processing unit determines if a request to perform a system recovery has been made (step 248). For example, processing unit 144 in hub 120 can determine from the extracted contents of the system maintenance request file if a request to perform a system recovery procedure is included. If (at step 248) the processing unit determines that a request to perform a system recovery procedure has not been made, then the flow proceeds to step 256.

If (at step 248) the processing unit determines that a request to perform a system recovery procedure has been made, then the processing unit retrieves, from the memory location on the USB drive, suitable bootloader, kernel and file system files, and stores these files in suitable memory locations to await execution and loading of the system files (step 250). The processing unit then executes the instructions in the bootloader and kernel files, and loads the file system information into the memory associated with the processing unit involved (step 252). Once the file system files have been loaded to the system involved, the processing unit can add a suitable entry to the system maintenance log, which indicates that the system recovery request procedure has been performed (step 254). The flow can then proceed to step 256.

Returning to step 248, if the processing unit determines that a request to perform a system recovery procedure has not been made, then the processing unit determines if a script execution request has been made (step 256). For example, processing unit 144 in hub 120 can determine from the extracted contents of the system maintenance request file if a request to execute script also contained in the contents of the system maintenance request file is included. If (at step 256) the processing unit determines that a request to execute script has not been made, then the flow proceeds to step 264.

If (at step 256) the processing unit determines that a request to execute script has been made, then the processing unit retrieves, from the memory location on the USB drive, the script to be executed, and executes the commands included in the script (step 258). For example, the script can include suitable instructions for performing predetermined maintenance procedures (e.g., diagnosis, debugging, repair, recovery, etc.) for one or more onsite components of system 100. The processing unit then schedules a suitable timeframe when the instructions in the script can be executed (step 260). For example, the processing unit can select a timeframe when the operations of the multiple-TRX base station 102 are not likely to be disrupted significantly by the script execution process. Once the script execution process is complete, the processing unit can add a suitable entry to the system maintenance log, which indicates that the script execution request procedure has been performed (step 262). The flow can then proceed to step 264.

Returning to step 256, if the processing unit determines that a request to execute script has not been made, the processing unit then copies the contents of the system maintenance log to the inserted USB drive (step 264). The processing unit then indicates to the user that the system maintenance mode's operations are completed (step 266). For example, in some embodiments, the processing unit (e.g., processing unit 144) can provide a visual indication (lit LED, etc.) to the user that the system, subsystem or component involved (e.g., multiple-TRX base station 102) has completed the operations of the system maintenance mode. Also, for example, the processing unit can send suitable information to a maintenance trap or in an email message, which indicates to a user (and/or customer, agent, service provider, support personnel, etc.) that the system has completed the operations of the system maintenance mode. The method for performing onsite maintenance of a wireless communication system can then be terminated (step 210).

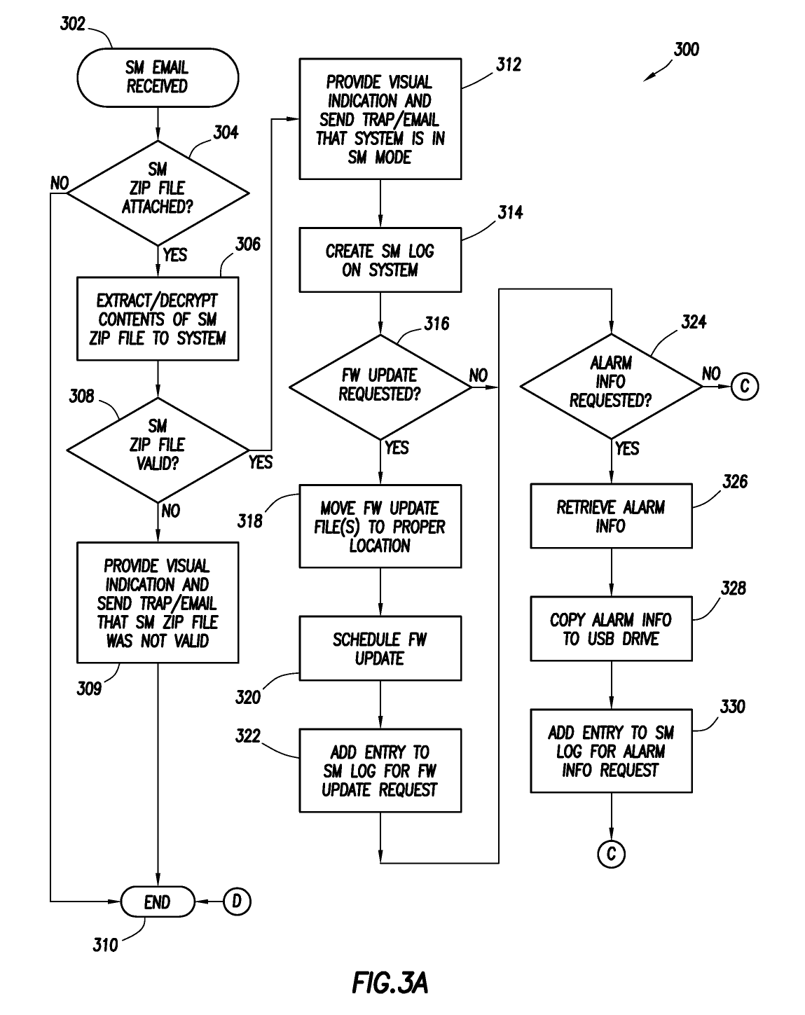

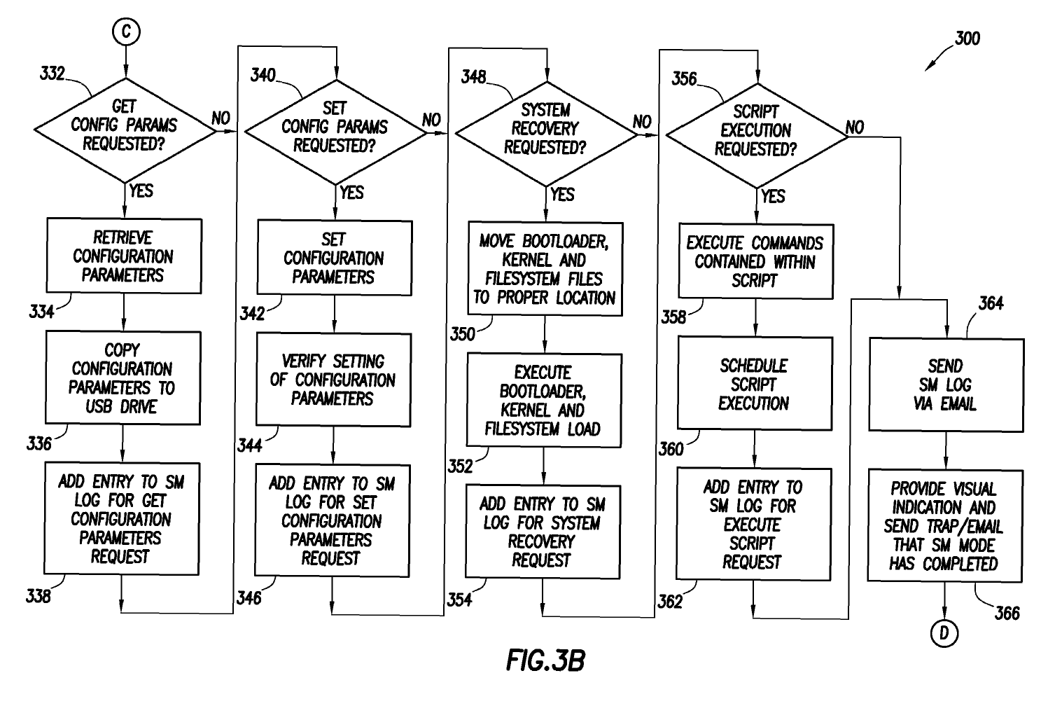

FIGS. 3A and 3B are related diagrams depicting a second exemplary method 300 for performing remote maintenance of a wireless communication system, which can be used to implement one or more embodiments of the present invention. For example, in some embodiments, method 300 can be used for performing system maintenance (e.g., diagnosis, debugging, recovery, rescue, repair, etc.) of one or more components of wireless communication system 100 depicted in FIG. 1 at a customer's or user's remote location. More precisely, for example, in some embodiments, method 300 can be implemented using a suitable system maintenance file attached to an email message, which is conveyed to a customer or user at a remote location and enables the performance of onsite system maintenance of one or more subsystems or components of wireless communication system 100 at the remote location.

Referring now to FIGS. 1, 3A and 3B for one or more embodiments, exemplary method 300 begins with an assumption that a suitable email message has been received at the onsite location of the remote components of the wireless communication system involved (step 302). For example, it may be assumed that an email message has been received by processing unit 146 located in building 134 by a customer or user, and the subject of the message is system maintenance for the remotely located equipment of system 100, such as one or more of multiple-TRX base station 102, TRX units 116, hub 120, expansion hubs 126 (e.g., if expansion hubs are included in the system involved), and antenna units 122. The processing unit 144 of the hub 120 is operable to receive such an email message (for example, by executing suitable software or firmware). After the processing unit 144 has received such an email message, the processing unit 144 then performs the processing described below automatically (that is, without requiring input from a user).

Next, a processing unit in the remotely located equipment of system 100 (e.g., processing unit 144 of hub 120) determines if a system maintenance file is attached to the received system maintenance email message (step 304). For example, such a system maintenance file can be a zip (compressed) file, and the contents of the file can be protected from unauthorized use by a suitable encryption algorithm. Also, for example, such a system maintenance file may include a system maintenance request file, and the system maintenance request file may include, but is not limited to, one or more firmware update file(s), configuration parameter list(s), bootloader, kernel or file system file(s), and script file(s). If (at step 304) the processing unit (e.g., processing unit 144) determines that no system maintenance file is attached to the received system maintenance email message, the flow can be terminated (step 310).

If (at step 304) the processing unit determines that a system maintenance file is attached to the received email message, then the processing unit can extract the contents of the system maintenance file from the attached file, and store the contents in memory associated with the system processing unit involved (step 306). For example, in some embodiments, the processing unit can decompress or unzip the contents of the system maintenance file in the email attachment, execute a suitable algorithm to decrypt the contents (e.g., if encrypted), and store the contents in memory associated with the system's processing unit (e.g., processing unit 144 in hub 120).

Next, the processing unit involved determines if the extracted file is a valid system maintenance file (step 308). For example, the processing unit can execute a suitable authentication algorithm on the contents of the extracted file to determine if the file is valid. If (at step 308) the processing unit determines that the extracted file is not a valid system maintenance file, then the processing unit can indicate to the user that the system maintenance file was not valid (step 309) and then the flow can be terminated (step 310). For example, in some embodiments, the processing unit (e.g., processing unit 144) can provide a visual indication (lit LED, etc.) to the user that the system maintenance file was not valid. Also, for example, the processing unit can send suitable information to a maintenance trap or in an email message, which indicates to a user (and/or customer, agent, service provider, support personnel, etc.) that the system maintenance file was not valid.

If (at step 308) the processing unit determines that the extracted file is a valid system maintenance file, then the processing unit indicates to the user that the system involved is in a system maintenance mode of operation (step 312). For example, in some embodiments, the processing unit (e.g., processing unit 144) can provide a visual indication (lit LED, etc.) to the user that the system, subsystem or component involved (e.g., multiple-TRX base station 102) is operating in a system maintenance mode. Also, for example, the processing unit can send suitable information to a maintenance trap or in an email message, which indicates to a user (and/or customer, agent, service provider, support personnel, etc.) that the system is operating in a system maintenance mode.

Next, the processing unit (e.g., processing unit 144) creates and stores a system maintenance log for the system involved (step 314). For example, the system maintenance log can be used to store entries associated with specific system maintenance procedures or responses to requests that have been performed. Next, the processing unit determines if a firmware update request has been made (step 316). For example, the processing unit can determine from the contents of the system maintenance request file if a firmware update request is included. If (at step 316) the processing unit determines that a firmware update request has not been made, then the flow proceeds to step 324.

If (at step 316) the processing unit determines that a firmware update request has been made, then the processing unit conveys the firmware files to be used for the update(s) to a suitable memory location in the equipment involved until the firmware update(s) can be performed (step 318). The processing unit then schedules a suitable timeframe when the firmware update(s) can occur (step 320). For example, the processing unit can select a timeframe when the operations of the multiple-TRX base station 102 are not likely to be disrupted significantly by the update process. Once the firmware update process is complete, the processing unit can add a suitable entry to the system maintenance log, which indicates that the firmware update request procedure has been performed (step 322). The flow can then proceed to step 324.

Returning to step 316, if the processing unit determines that no firmware update request has been made, the processing unit then determines if a system maintenance alarm information request has been made (step 324). For example, processing unit 144 in hub 120 can determine from the extracted contents of the system maintenance request file if an alarm information request is included. Such system maintenance alarm information may include, for example, information indicating that the system (e.g., processing unit 144) has identified a problem with the performance of the system, subsystem or component involved, and the problem requires system maintenance to be performed. If (at step 324) the processing unit determines that an alarm information request has not been made, then the flow proceeds to step 332.

If (at step 324) the processing unit determines that a system maintenance alarm information request has been made, the processing unit retrieves the alarm information from a suitable memory location in the system where the alarm information has been stored (step 326). The processing unit then stores the retrieved alarm information in a suitable memory storage device (step 328). Once the alarm information has been copied to the memory storage device, the processing unit can add a suitable entry to the system maintenance log, which indicates that the alarm information request procedure has been performed (step 330). The flow can then proceed to step 332.

Returning to step 324, if the processing unit determines that an alarm information request has not been made, the processing unit then determines if a request to retrieve system configuration parameters has been made (step 332). For example, processing unit 144 in hub 120 can determine from the extracted contents of the system maintenance request file if a request to retrieve the system's configuration parameters is included. If (at step 332) the processing unit determines that a request to retrieve system configuration parameters has not been made, then the flow proceeds to step 340.

If (at step 332) the processing unit determines that a request to retrieve system configuration parameters has been made, then the processing unit retrieves a configuration parameter list from a suitable memory location in the system where the system's configuration parameter information has been stored (step 334). The processing unit then stores the retrieved configuration parameter information in the memory storage device (step 336). Once the system's configuration parameter information has been copied to the memory storage device, the processing unit can add a suitable entry to the system maintenance log, which indicates that the retrieve configuration parameters request procedure has been performed (step 338). The flow can then proceed to step 340.

Returning to step 332, if the processing unit determines that a request to retrieve system configuration parameters has not been made, then the processing unit determines if a request to set the system's configuration parameters has been made (step 340). For example, processing unit 144 in hub 120 can determine from the extracted contents of the system maintenance request file if a request to set the system's configuration parameters is included. If (at step 340) the processing unit determines that a request to set the system's configuration parameters has not been made, then the flow proceeds to step 348.

If (at step 340) the processing unit determines that a request to set the system's configuration parameters has been made, then the processing unit retrieves a configuration parameter list from a suitable memory location, and sets the system's configuration parameters in accordance with the list (step 342). The processing unit then verifies that the configuration parameter have been set in accordance with the list (step 344). Once the system's configuration parameters have been set and verified, the processing unit can add a suitable entry to the system maintenance log, which indicates that the set configuration parameters request procedure has been performed (step 346). The flow can then proceed to step 348.

Returning to step 340, if the processing unit determines that a request to set the system's configuration parameters has not been made, then the processing unit determines if a request to perform a system recovery procedure has been made (step 348). For example, processing unit 144 in hub 120 can determine from the extracted contents of the system maintenance request file if a request to perform a system recovery procedure is included. If (at step 348) the processing unit determines that a request to perform a system recovery procedure has not been made, then the flow proceeds to step 356.

If (at step 348) the processing unit determines that a request to perform a system recovery procedure has been made, then the processing unit retrieves, from a suitable memory storage location, suitable bootloader, kernel and file system files, and stores these files in certain memory locations to await execution and loading of the system files (step 350). The processing unit then executes the instructions in the bootloader and kernel files, and loads the file system information in the memory associated with the processing unit involved (step 352). Once the file system files have been loaded to the system involved, the processing unit can add a suitable entry to the system maintenance log, which indicates that the system recovery request procedure has been performed (step 354). The flow can then proceed to step 356.

Returning to step 348, if the processing unit determines that a request to perform a system recovery procedure has not been made, then the processing unit determines if a script execution request has been made (step 356). For example, processing unit 144 in hub 120 can determine from the extracted contents of the system maintenance request file if a request to execute script also contained in the contents of the system maintenance request file is included. If (at step 356) the processing unit determines that a request to execute script has not been made, then the flow proceeds to step 364.

If (at step 356) the processing unit determines that a request to execute script has been made, then the processing unit retrieves, from a suitable memory location, the script to be executed, and executes the commands included in the script (step 358). For example, the script can include suitable instructions for performing predetermined maintenance procedures (e.g., diagnosis, debugging, repair, recovery, etc.) for one or more onsite components of system 100. The processing unit then schedules a suitable timeframe when the instructions in the script can be executed (step 360). For example, processing unit 144 can select a timeframe when the operations of the multiple-TRX base station 102 are not likely to be disrupted significantly by the script execution process. Once the script execution process is complete, the processing unit can add a suitable entry to the system maintenance log, which indicates that the script execution request procedure has been performed (step 362). The flow can then proceed to step 364.

Returning to step 356, if the processing unit determines that a request to execute script has not been made, the processing unit emails the system maintenance log file to the service provider as an attachment to an email message (step 364). The processing unit then indicates to the user that the system maintenance mode's operations are completed (step 366). For example, in some embodiments, the processing unit (e.g., processing unit 144) can provide a visual indication (lit LED, etc.) to the user that the system, subsystem or component involved (e.g., multiple-TRX base station 102) has completed the operations of the system maintenance mode. Also, for example, the processing unit can send suitable information to a maintenance trap or in an email message, which indicates to a user (and/or customer, agent, service provider, support personnel, etc.) that the system has completed the operations of the system maintenance mode. The method for performing onsite maintenance of a wireless communication system can then be terminated (step 310).

It is important to note that while the present invention has been described in the context of a fully functioning method and system for performing onsite maintenance of a wireless communication system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular method and system for performing onsite maintenance of a wireless communication system.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A method for performing system maintenance in a wireless communication system, comprising:
storing a plurality of system maintenance files for the wireless communication system in a memory storage device;
physically coupling the memory storage device to an interface included in the wireless communication system;
retrieving from the memory storage device at least one of the plurality of system maintenance files; and
automatically performing at least one system maintenance action related to the at least one system maintenance file.

2. The method of claim 1, further comprising:
creating a system maintenance log; and
after performing the at least one system maintenance action related to the at least one system maintenance file, adding an entry to the system maintenance file related to the at least one system maintenance action.

3. The method of claim 2, wherein performing the at least one system maintenance action related to the at least one system maintenance file comprises copying the system maintenance log to the memory storage device.

4. The method of claim 1, further comprising:
causing at least a part of the wireless communication system to enter a system maintenance mode when the at least one of the plurality of system maintenance files is successfully retrieved and determined to be valid;
providing a first visual indication that the at least a part of the wireless communication system is in the system maintenance mode; and
causing the at least a part of the wireless communication system to exit the system maintenance mode after performing the at least one system maintenance action related to the at least one system maintenance file; and
providing a second visual indication that the at least a part of the wireless communication system has exited the system maintenance mode.

5. The method of claim 4, further comprising:
sending at least one of a first trap or first email when the at least a part of the wireless communication system is in the system maintenance mode; and
sending at least one of a second trap or second email when the at least a part of the wireless communication system has exited the system maintenance mode.

6. The method of claim 1, wherein the plurality of system maintenance files are stored on the memory storage device in a compressed form and wherein the method further comprises uncompressing the compressed form of the plurality of system maintenance files.

7. The method of claim 1, wherein the plurality of system maintenance files comprises at least one firmware or software update file, and wherein performing the at least one system maintenance action related to the at least one system maintenance file comprises:
moving the at least one firmware or software update file to a location in the wireless communication system; and
scheduling an update operation to be performed using the at least one firmware or software update file.

8. The method of claim 1, wherein performing the at least one system maintenance action related to the at least one system maintenance file comprises at least one of:
(a) retrieving alarm information from at least a part of the wireless communication system, and copying the alarm information to the memory storage device;
(b) retrieving configuration parameters from at least a part of the wireless communication system, and copying the configuration parameters to the memory storage device.
(c) setting at least one configuration parameter for at least a part of the wireless communication system based at least in part on at least one system maintenance file, and verifying that the at least one configuration parameter for the at least one part of the wireless communication has been in accordance with the at least one system maintenance file;
(d) performing a system recovery; and
(e) causing at least a part of the wireless communication system to execute the at least one system maintenance file.

9. The method of claim 8, wherein performing the system recovery comprises moving at least one of a boot loader, a kernel, and filesystem files to a location in the wireless communication system, and executing the loading of the least at least one of the boot loader, the kernel, and the filesystem files.

10. The method of claim 8, wherein the at least one system maintenance file that is executed comprises a script and wherein executing the at least one maintenance file comprises at least one of causing the at least a part of the wireless communication system to execute at least some of the commands contained within the script and scheduling a time for at least some of the commands contained within the script to be executed by the at least a part of the wireless communication system.

11. The method of claim 1, wherein the memory storage device comprises at least one of: a compact flash memory device, a secure digital memory device, a USB memory device, a magnetic disk, an optical disk, and a magnetic tape.

12. A distributed antenna system comprising:
a hub unit;
a plurality of remote antenna units, wherein the hub unit is communicatively coupled to plurality of remote antenna units;
wherein the hub unit comprises a processing unit, and an interface communicatively coupled to the processing unit;
wherein the processing unit is operable to:
determine when a memory storage device is physically coupled to the interface; and
when the memory storage device is physically coupled to the interface, determine if at least one system maintenance file is stored on the memory storage device and, if at least one system maintenance file is stored on the memory storage device, automatically perform at least one system maintenance operation related to the at least one system maintenance file.

13. The distributed antenna system of claim 12, wherein interface is operable to physically couple at one of the following to hub unit: a compact flash memory device, a secure digital memory device, a USB memory device, a magnetic disk, an optical disk, and a magnetic tape.

14. The distributed antenna system of claim 12, further comprising at least one expansion hub, wherein the at least one of the plurality of remote antenna units is communicatively coupled to the hub via the expansion hub.

15. The distributed antenna system of claim 12, wherein the distributed antenna system is located a first location and the system maintenance files are stored on the memory storage device at a location other than the first location, wherein the memory storage device is conveyed to the first location in order to be physically, directly connected to the interface.

16. The distributed antenna system of claim 12, wherein the hub is communicatively coupled to at least one base station.

17. A method for performing system maintenance in a wireless communication system, comprising:
attaching a plurality of system maintenance files for the wireless communication system to a first email message;
emailing the email message to the wireless communication system;
retrieving from the first email message at least one of the plurality of system maintenance files; and
automatically performing at least one system maintenance action related to the at least one system maintenance file.

18. The method of claim 17, further comprising:
creating a system maintenance log; and
after performing the at least one system maintenance action related to the at least one system maintenance file, adding an entry to the system maintenance file related to the at least one system maintenance action.

19. The method of claim 18, wherein performing the at least one system maintenance action related to the at least one system maintenance file comprises attaching a copy of the system maintenance log to a second email message and emailing the second email message to a device that is located at a different location than the wireless communication system.

20. The method of claim 17, further comprising:
causing at least a part of the wireless communication system to enter a system maintenance mode when the at least one of the plurality of system maintenance files is successfully retrieved and determined to be valid;
providing a first visual indication that the at least a part of the wireless communication system is in the system maintenance mode; and
causing the at least a part of the wireless communication system to exit the system maintenance mode after performing the at least one system maintenance action related to the at least one system maintenance file; and
providing a second visual indication that the at least a part of the wireless communication system has exited the system maintenance mode.

21. The method of claim 20, further comprising:
sending at least one of a first trap or a third email message when the at least a part of the wireless communication system is in the system maintenance mode; and
sending at least one of a second trap or a fourth email message when the at least a part of the wireless communication system has exited the system maintenance mode.

22. The method of claim 17, wherein the plurality of system maintenance files are attached to the first email message in a compressed form and wherein the method further comprises uncompressing the compressed form of the plurality of system maintenance files.

23. The method of claim 17, wherein the plurality of system maintenance files comprises at least one firmware or software update file, and wherein performing the at least one system maintenance action related to the at least one system maintenance file comprises:
moving the at least one firmware or software update file to a location in the wireless communication system; and
scheduling an update operation to be performed using the at least one firmware or software update file.

24. The method of claim 17, wherein performing the at least one system maintenance action related to the at least one system maintenance file comprises:
(a) retrieving alarm information from at least a part of the wireless communication system, attaching the alarm information to a second email message, and emailing the second email message to a device that is located at a different location than the wireless communication system;
(b) retrieving configuration parameters from at least a part of the wireless communication system, attaching the configuration parameters to a second email message; and emailing the second email message to a device that is located at a different location than the wireless communication system;
(c) setting at least one configuration parameter for at least a part of the wireless communication system based at least in part on at least one system maintenance file, and verifying that the at least one configuration parameter for the at least one part of the wireless communication has been set in accordance with the at least one system maintenance file;
(d) performing a system recovery; and
(e) causing at least a part of the wireless communication system to execute the at least one system maintenance file.

25. The method of claim 24, wherein performing the system recovery comprises:
moving at least one of a boot loader, a kernel, and filesystem files to a location in the wireless communication system; and
executing the loading of the least at least one of the boot loader, the kernel, and the filesystem files.

26. The method of claim 24, wherein the at least one system maintenance file that is executed comprises a script and wherein executing the at least one maintenance file comprises at least one of causing the at least a part of the wireless communication system to execute at least some of the commands contained within the script and scheduling a time for at least some of the commands contained within the script to be executed by the at least a part of the wireless communication system.

27. A distributed antenna system comprising:
a hub unit;
a plurality of remote antenna units, wherein the hub unit is communicatively coupled to plurality of remote antenna units;
wherein the hub unit comprises a processing unit, and an interface communicatively coupled to the processing unit;
wherein the processing unit is operable to receive a first email message comprising at least one system maintenance file attached thereto; and
wherein the processing unit is operable to perform at least one system maintenance operation related to the at least one system maintenance file after the processing unit receives the first email message.

28. The distributed antenna system of claim 27, further comprising at least one expansion hub, wherein the at least one of the plurality of remote antenna units is communicatively coupled to the hub via the expansion hub.

29. The distributed antenna system of claim 27, wherein distributed antenna system is located a first location, and wherein the first email message is sent from a device located at a location that is different from the first location.

30. The distributed antenna system of claim 27, wherein the hub is communicatively coupled to at least one base station.
